(19) United States
(12) Patent Application Publication
(10) Pub. No.: US 2026/0031969 A1
(43) Pub. Date: Jan. 29, 2026

(54) SPUR AND NOISE REDUCTION FOR TELECOMMUNICATION SYSTEMS

(71) Applicant: Skyworks Solutions, Inc., Irvine, CA (US)

(72) Inventors: Florinel G. Balteanu, Irvine, CA (US); Saunak Sarkar, Irvine, CA (US); Joshua Haeseok Cho, Irvine, CA (US); Yunyoung Choi, Irvine, CA (US)

(21) Appl. No.: 19/241,707

(22) Filed: Jun. 18, 2025

Related U.S. Application Data
(60) Provisional application No. 63/662,542, filed on Jun. 21, 2024.

(51) Int. Cl. H04L 7/033; H04J 3/06

(52) U.S. Cl. CPC H04L 7/033; H04J 3/0635

(57) ABSTRACT

A system for providing a clock signal to a telecommunications is presented. The system has a clock circuit configured to provide a first clock signal having a first frequency and a second clock signal having a second frequency, the second frequency being higher than the first frequency, and an event detector. The event detector is configured to detect a plurality of events in the telecommunications circuit, the plurality of events corresponding to operations performed by components of the telecommunications circuit, control the clock circuit to provide the second clock signal in response to detecting an event of the plurality of events for at least a duration of the event, and control the clock circuit to provide the first clock signal and to stop providing the second clock signal after at least the duration of the event.

### CROSS-REFERENCE TO RELATED APPLICATIONS

This application claims priority under 35 U.S.C. § 119(e) to U.S. Provisional Patent Application No. 63/662,542, titled SPUR AND NOISE REDUCTION FOR TELECOMMUNICATION SYSTEMS, filed on Jun. 21, 2024, which is hereby incorporated by reference in its entirety for all purposes.

### BACKGROUND

### 1. Field of the Disclosure

At least one example in accordance with the present disclosure relates generally to RF Front End Modules.

### 2. Discussion of Related Art

Telecommunication systems often process periodic signals of various types.

### SUMMARY

According to at least one aspect of the present disclosure, a system for providing a clock signal to a telecommunications circuit is presented. The system comprises a clock circuit configured to provide a first clock signal having a first frequency and a second clock signal having a second frequency, the second frequency being higher than the first frequency, and an event detector. The event detector is configured to detect a plurality of events in the telecommunications circuit, the plurality of events corresponding to operations performed by components of the telecommunications circuit, control the clock circuit to provide the second clock signal in response to detecting an event of the plurality of events for at least a duration of the event, and control the clock circuit to provide the first clock signal and to stop providing the second clock signal after at least the duration of the event.

In some examples, the telecommunications circuit has a first operating mode and a second operating mode, and the event detector is configured to control the clock circuit to provide the first clock signal during the first operating mode and to provide the second clock signal during the second operating mode. In some examples, the second operating mode corresponds to one or more periods of time during at least one duration of one or more events of the plurality of events. In some examples the plurality of events includes one or more of a switch changing state or a temperature sensor detecting a temperature. In some examples, the system further comprises an oscillator configured to provide a periodic signal to the clock circuit. In some examples, the system further comprises a clock generator configured to receive the periodic signal and to output one or more clock generation signals, the second clock signal being based on the one or more clock generation signals. In some examples, the first clock signal is based on the one or more clock generation signals. In some examples, the system further comprises a multiplexer, the multiplexer being configured to receive the first clock signal and the second clock signal and to provide one of the first clock signal and the second clock signal to the telecommunications circuit based on a control signal provided by the event detector. In some examples, the event detector includes at least one controller configured to provide the control signal to the multiplexer based on events detected by the event detector.

According to at least one aspect of the present disclosure, clock circuitry is presented, comprising an oscillator configured to provide a first periodic signal; a clock multiplier coupled to the oscillator and configured to provide a second periodic signal having a frequency higher than the first periodic signal; a clock divider coupled to the oscillator and configured to provide a third periodic signal having a frequency lower than the first periodic signal; and a multiplexer coupled to the clock multiplier and the clock divider having an output to provide one of the second periodic signal and the third period to an output configured to be coupled to a telecommunication circuit and configured to receive a received signal corresponding to one of the first period signal, second periodic signal, or third periodic signal, and configured to provide the received signal to the telecommunication circuit.

In some examples, the clock multiplier is configured to receive the first periodic signal and to generate the second periodic signal based on the first periodic signal. In some examples, the clock divider is configured to receive the first periodic signal and to generate the third periodic signal based on the first periodic signal. In some examples, the clock multiplier is coupled to the clock divider and is configured to receive one or more periodic signals from the clock divider, the clock multiplier being further configured to generate the second periodic signal based on the one or more periodic signals. In some examples, the multiplexer is configured to receive the second periodic signal and the third periodic signal and to provide one of the second periodic signal or third periodic signal to the output. In some examples, the clock circuitry has a first mode and a second mode. In some examples, in the first mode, the output receives the second periodic signal. In some examples, in the second mode, the output receives the third periodic signal. In some examples, the circuitry further comprises an event detector, the event detector configured to detect at least one event and to provide a mode selection signal to at least the multiplexer based on the at least one event. In some examples, the at least one event corresponds to an operation of a circuit that requires or benefits from a fast clock signal, and wherein the event detector is configured to provide a mode selection signal to the multiplexer causing the multiplexer to provide the second periodic signal to the output. In some examples, the event detector is further configured to detect an end of the event and, responsive to detecting the end of the event, provide the mode selection signal to at least the multiplexer causing the multiplexer to provide the third periodic signal to the output.

In some examples, the clock circuitry further comprises a second output; a second clock multiplier coupled to the oscillator and configured to provide a fourth periodic signal; a second clock divider coupled to the oscillator and configured to provide a fifth periodic signal; a second multiplexer coupled to the second clock multiplier and the second clock divider and configured to receive the fourth periodic signal and the fifth periodic signal, and configured to provide one of the fourth periodic signal or fifth periodic signal to the second output. In some examples, the event detector is configured to provide the mode selection signal to at least the multiplexer and the second multiplexer. In some examples, the event detector is configured to provide a second mode selection signal to at least the second multiplexer.

In some examples, the clock divider includes a plurality of switchable inverter segments coupled in series with one another, including a first switchable inverter segment and a last switchable inverter segment, wherein a segment output of the last switchable inverter segment is coupled to a segment input of the first switchable inverter segment and is also coupled to a divider output of the clock divider. In some examples, each switchable inverter segment of the plurality of switchable inverter segments includes: an inverter; a phase output coupled to an output of the inverter; a capacitor coupled between the output of the inverter and a switching device; and a reference node coupled to the switching device. In some examples, the output of each respective switchable inverter segment of the plurality of switchable inverter segments is coupled to a respective input of a different switchable inverter segment of the plurality of switchable inverter segments, such that no output of a switchable inverter segment of the plurality of switchable inverter segments is coupled to an output of a different switchable inverter segment of the plurality of switchable inverter segments. In some examples, the output of the inverter is coupled to the output of the inverter's respective switchable inverter segment. In some examples, the circuitry further comprises an event detector, wherein the event detector is configured to provide a mode selection signal to each switching device of the plurality of switchable inverter segments, wherein the mode selection signal determines whether each respective switching device is open or closed.

In some examples, the clock divider includes: a voltage rail; a reference node; a buffer having a buffer input and a buffer output; a first resistor coupled to the buffer input; a second resistor coupled to the buffer input; a first switching device coupled between the voltage rail and the first resistor; a second switching device coupled between the voltage rail and a third switching device, the third switching device being coupled between the second switching device and the second resistor; a fourth switching device coupled between the reference node and the first resistor; a fifth switching device coupled between the reference node and a sixth switching device, the sixth switching device being coupled between the fifth switching device and the second resistor; a first capacitor coupled between the buffer input and the reference node; a second capacitor coupled between the buffer input and a seventh switching device, the seventh switching device being couped between the second capacitor and the reference node; and a first inverter having an output coupled to the input of a second inverter, wherein the output of the first inverter is furth coupled sixth switching device and an output of the second inverter is coupled to the second switching device and the seventh switching device, and the buffer output is coupled to a clock output and the first switching device, the third switching device, the fourth switching device, and the fifth switching device.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates an RF switch according to an example;

FIG. 1B illustrates an RF switch according to an example;

FIG. 1C illustrates an RF switch according to an example;

FIG. 2 illustrates a clock system according to an example;

FIG. 3 illustrates a clock generator according to an example;

FIG. 4 illustrates a clock generator according to an example;

FIG. 5 illustrates a clock system according to an example;

FIG. 6 illustrates a process for providing clock signals according to an example;

FIG. 7 illustrates a mobile device according to an example;

FIG. 8A illustrates a front end module according to an example; and

FIG. 8B illustrates a front end module according to an example.

### DETAILED DESCRIPTION

In some telecommunication systems, circuit components of the system may generate noise or spurs that interfere with the operation of the system or distort or change the radio frequency (RF) signals being sent and/or received by the system. In these examples, noise may refer to any unwanted signals or signal components, including spurs, while spurs may refer to signals that rise in amplitude around a particular frequency or set of frequencies (e.g., frequency bins).

In some telecommunication systems, such as those which support 5G communications, amplifiers within the transmit and receive paths, such as low noise amplifiers (LNAs) or power amplifiers, may use the same voltage rails as other circuit blocks, such as temperature sensors, calibration circuitry, and other large circuit blocks. These other circuit blocks may be coupled to a clock that provides a periodic clock signal, with frequencies typically between 1 MHz-100 MHz, and components of the periodic clock signal may appear on the voltage rails. Likewise, when the circuit blocks (such as temperature sensors or calibration circuitry) are active, those blocks may draw power and/or output signals in such a way that noise or spurs are induced or created on the voltage rails. In some cases, where the LNA and power amplifier biases are coupled to the same supply voltage (e.g., the same voltage rails) as the clock-operated circuitry (e.g., elements of the circuit whose function is tied to the clock signal), then noise, including RF noise, and spurs may be inevitable or otherwise unavoidable.

Furthermore, the LNAs and power amplifiers may not be tied directly to the clock operation, or may operate at different clock frequencies compared to the other clock-operated circuitry. As a result, the clock may be providing control signals to all clock-operated circuitry at a higher frequency than is necessary, thus causing the system to use a substantial amount of power on average.

Aspects and elements of this disclosure relate to systems and methods for reducing the power consumption of telecommunication systems, including 5G telecommunication systems, and for reducing noise and spurs in the telecommunication system.

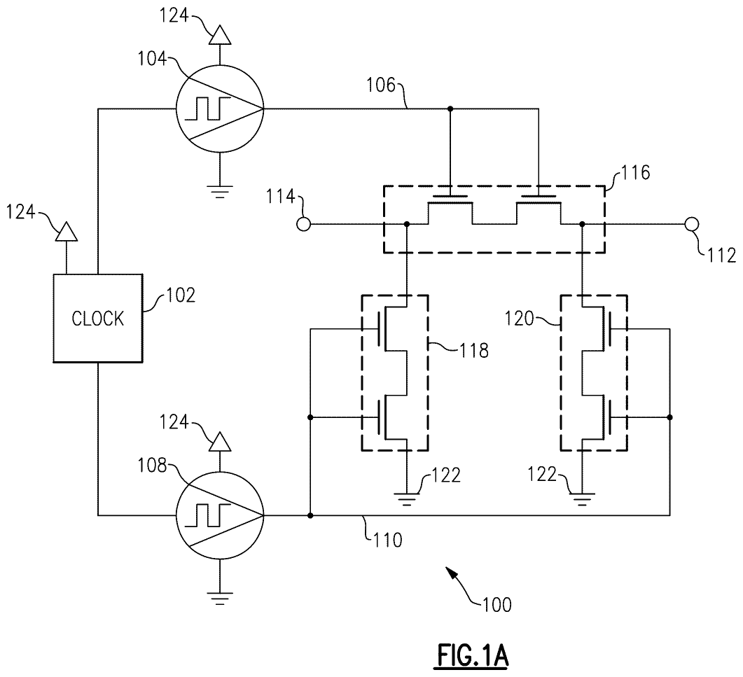

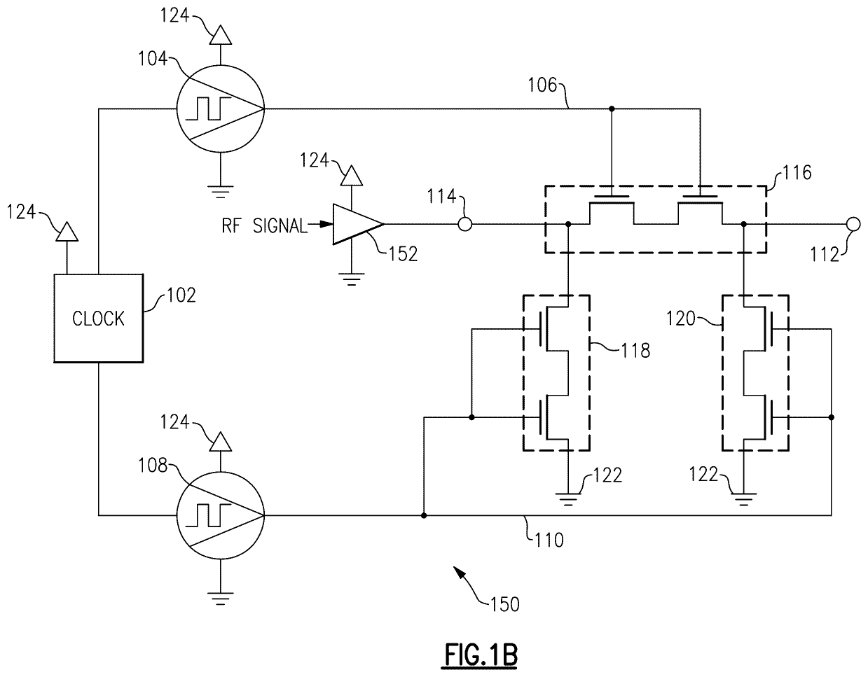

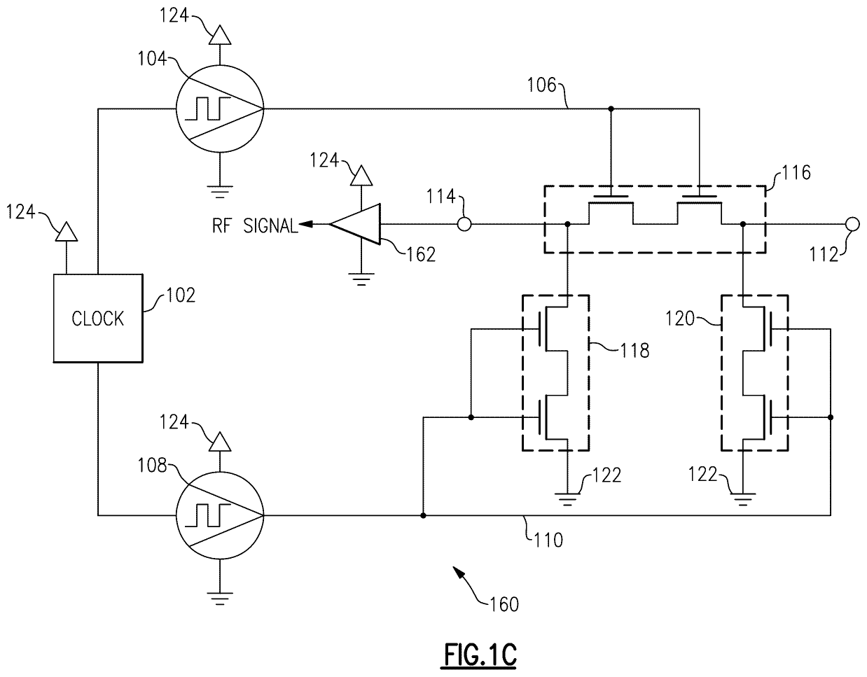

FIG. 1A illustrates an RF switch 100 according to an example. The RF switch 100 includes a clock 102, a first charge pump 104, a first voltage rail 106, a second charge pump 108 a second voltage rail 110, an antenna connection 112, an I/O connection 114, a series switch 116, a first shunt switch 118, a second shunt switch 120, a reference node 122, and a high voltage node.

The RF switch 100 is designed for either the transmit or receive path of a front-end module (FEM). That is, the RF switch 100 may be used to provide an RF signal from the I/O connection 114 to the antenna connection 112, or provide an RF signal from the antenna connection 112 to the I/O connection 114. The RF switch 100 may also shunt RF signals to the reference node 122 when it is not desired to receive or transmit a signal, depending on how the RF switch 100 is configured. In some communication systems there may be multiple RF switches, for example, at least one for the receive path and at least one for the transmit path.

The clock 102 is coupled to the first charge pump 104 and the second charge pump 108. An output of the first charge pump 104 is coupled to the first voltage rail 106. An output of the second charge pump 108 is coupled to the second voltage rail 110. The first voltage rail 106 is coupled to the gates of the transistors making up the series switch 116. The second voltage rail 110 is coupled to the gates of the transistors making up the first and second shunt switches 118, 120. The series switch 116 has a first connection coupled to the antenna connection 112 and to a first connection of the second shunt switch 120. The series switch 116 has a second connection coupled to the I/O connection 114 and to a first connection of the first shunt switch 118. Both the first and second shunt switches 118, 120 have a respective second connection coupled to the reference node 122.

The high voltage node 124 is coupled to the clock 102, the first charge pump 104, and the second charge pump 108. The reference node 122 is coupled to the first and second charge pump 104, 108. These nodes may be used to power or drive the charge pumps 104, 108. The reference node 122 and high voltage node 124 may be pathways through which RF spurs and/or RF noise may propagate. However, RF spurs and noise may also propagate electromagnetically without a galvanic connection (or a direct galvanic connection) between components of the circuit in which the RF switch 100 is situated.

The clock 102 may provide a control signal to the charge pumps 104, 108 and/or clock-operated circuitry in a telecommunications circuit, FEM, and so forth.

As mentioned above, the switches 116, 118, 120 may be comprised of one or more transistors (of any type) or other switching devices (e.g., relays). Those transistors (or other switching devices) are controlled by voltages present on the first and second voltage rails 106, 110. The transistors may also be coupled together in a series configuration between the respective first connection and second connection of the switch 116, 118, 120 to which they belong. The switches 116, 118, 120 may be operated to be open or closed. For example, the switches 116, 118, 120 may be all closed (e.g., on or conducting) when supplied with a positive voltage on the voltage rail 106, 110 to which the switch 116, 118, 120 is connected, and all open (e.g., off or not conducting) when supplied with a negative voltage on the voltage rail 106, 110 to which the switch 116, 118, 120 is connected. Thus, if the first voltage rail 106 has a positive voltage, the first switch 116 will be closed, and if the first voltage rail 106 has a negative voltage, the first switch 116 will be open. Likewise, if the second voltage rail 110 has a positive voltage, the shunt switches 118, 120 will be closed, and if the second voltage rail 110 has a negative voltage, the shunt switches 118, 120 will be open. Note, however, that other configurations are possible (e.g., one or more of the switches 116, 118, 120 could be configured to be closed when its respective voltage rail 106, 110 has a negative voltage, and open when the respective voltage rail 106, 110 has a positive voltage).

The RF switch 100 may therefore operate as follows: if the RF switch is configured to receive an RF signal at the antenna connection 112 and provide that signal to the I/O connection 114, then when it is desired to receive an RF signal, the first voltage rail 106 may have a voltage configured to close the series switch 116, while the second voltage rail 110 may have a voltage configured to open the shunt switches 118, 120. This configuration allows a signal to pass from the antenna connection 112 to the I/O connection 114 through the series switch 116 without being shunted to the reference node 122. However, at times RF signals may be present but may not be desired to be received. In such cases, the first voltage rail 106 may have a voltage configured to open the series switch 116, and the second voltage rail 110 may have a voltage configured to close the shunt switches 118, 120. This configuration will then route an RF signal received at the antenna connection 112 to the reference node 122 through the second shunt switch 120, and may also route any signals present at the I/O node 114 (e.g., reflected signals, noise, and so forth) to the reference node 122.

Conversely, if the RF switch 100 is configured to transmit an RF signal at the I/O connection 114 via an antenna coupled to the antenna connection 112, the voltage at the first voltage rail 106 may be configured to close the series switch 116 and the voltage at the second voltage rail 110 may be configured to open the shunt switches 118, 120 when transmitting a signal. When not transmitting a signal, the voltage at the first voltage rail 106 may be configured to open the series switch 116, and the voltage at the second voltage rail 110 may be configured to close the shunt switches 118, 120. Thus, when the series switch 116 is closed and the shunt switches 118, 120 are open, a signal can pass from the I/O connection 114 to the antenna connection 112. When the series switch 116 is open and the shunt switches 118, 120 are closed, signals at the I/O connection 114 and/or antenna connection 112 may instead be shunted through the shunt switches 118, 120 to the reference node 122.

In some examples, the reference node 122 may be coupled to ground.

To generate the desired voltages on the first voltage rail 106 and/or second voltage rail 110, the charge pumps 104, 108 may be used. The first charge pump 104 may determine the voltage on the first voltage rail 106 based on the voltage level to which the first charge pump 104 is configured to bring the first voltage rail 106 voltage. Likewise, the second charge pump 108 may determine the voltage on the second voltage rail 110 based on the voltage level to which the second charge pump 108 is configured to bring the second voltage rail 110 voltage. In some examples, the first voltage rail 106 may be a first supply voltage rail (e.g., the VDD voltage rail or higher positive voltage), and the second voltage rail 110 may be a second supply voltage rail (e.g., the VSS voltage rail or lower negative voltage).

In situations where the voltage rails 106, 110 are supply voltage rails, and the clock is coupled to clock-operated circuitry that are coupled to the supply voltage rails, noise and spurs can appear on the voltage rails 106, 110 as described above. Because the switches 116, 118, 120 are operated based on voltages on the voltage rails 106, 110, the operation of the switches 116, 118, 120 can be impacted by spurs or noise (e.g., the switches 116, 118, 120 may take longer to turn on or off, or may turn on or off when they are not supposed to, and so forth).

FIG. 1B illustrates an RF switch 150 according to an example. The RF switch 150 is identical to the RF switch 100 of FIG. 1A, except that a power amplifier 152 has been added. The power amplifier 152 has an output coupled to the I/O connection 114, and an input configured to receive an RF signal and/or a signal based on an RF signal, a first rail connection coupled to the first voltage rail 106, and a second rail connection coupled to the second voltage rail 110. The power amplifier 152 may be configured to amplify the RF signal and provide the amplified RF signal to the I/O connection 114. In some examples, the power amplifier 152 may use a variable duty cycle to provide an average power or frequency output based on the RF signal.

The high voltage node 124 and reference node 122 are coupled to the power amplifier 152.

Noise and spurs on the voltage rails 106, 110 may change the voltage at the rail connections of the power amplifier 152. As the voltage of the output of the power amplifier 152 may depend on the voltages received from the voltage rails 106, 110 via the rail connections, the noise and spurs caused by the clock and/or charge pumps and/or clock-operated circuitry connected to the voltage rails 106, 110 may distort or alter the output of the power amplifier 152.

FIG. 1C illustrates an RF switch 160 according to an example. The RF switch 160 is identical to the RF switch 100 of FIG. 1A, except that an LNA 162 has been added. The LNA 162 has an output configured to provide an RF signal to a circuit or device, an input coupled to the I/O connection 114, a first rail connection coupled to the first voltage rail 106, and a second rail connection coupled to the second voltage rail 110. In some examples, the LNA 162 may use a variable duty cycle to provide an average power or frequency output based on the RF signal.

The high voltage node 124 and reference node 122 are coupled to the LNA 162.

Noise and spurs on the voltage rails 106, 110 may change the voltage at the rail connections of the LNA 162. As the voltage of the output of the LNA 162 may depend on the voltages received from the voltage rails 106, 110 via the rail connections, the noise and spurs caused by the clock and/or charge pumps and/or clock-operated circuitry connected to the voltage rails 106, 110 may distort or alter the output of the LNA 162.

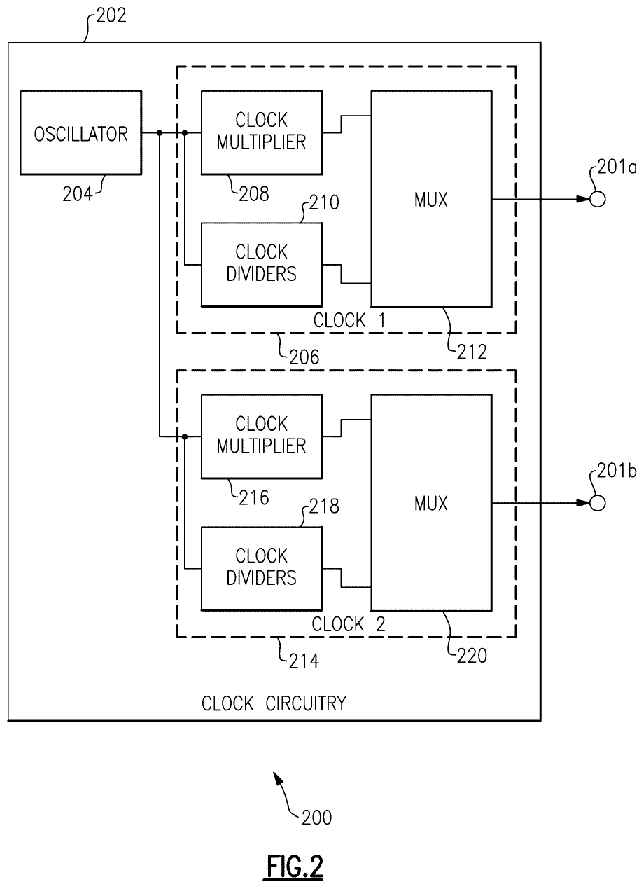

FIG. 2 illustrates a clock system 200 according to an example. The clock system 200 may reduce or eliminate noise and spurs in a telecommunication system, such as the systems 100, 150, 160 of FIGS. 1A-C.

The clock system 200 includes clock circuitry 202, a first clock output 201a, and a second clock output 201b. The clock circuitry 202 includes an oscillator 204, a first clock 206, and a second clock 214. The first clock includes a first clock multiplier 208, a first clock divider 210, and a first multiplexer 212. The second clock 214 includes a second clock multiplier 216, a second clock divider 218, and a second multiplexer 220. The clock circuitry 202 may, in some examples, include additional clocks (e.g., a third clock, a forth clock, and so forth).

The oscillator 204 is coupled to each clock multiplier 208, 216 and each clock divider 210, 218. The first clock multiplier 208 and the first clock divider 210 are coupled to the first multiplexer 212. The first multiplexer 212 is coupled to the first clock output 201a. The second clock multiplier 216 and the second clock divider 218 are coupled to the second multiplexer 220. The second multiplexer 220 is coupled to the second clock output 201b.

The oscillator 204 is configured to provide a time-varying signal, which may be a time-varying voltage and/or current, to the clocks 206, 214. In some examples, the oscillator 204 provides the time-varying voltage to the multipliers 208, 216 and the dividers 210, 218.

The first clock multiplier 208 is configured to receive the time-varying signal and to increase the frequency and/or decrease the period of the time-varying signal, and to provide the resulting multiplier output to the multiplexer 212. For example, if the time-varying signal from the oscillator 204 has a period of x seconds, the first clock multiplier 208 may change the period to nx seconds, where n is less than or equal 1. Note that decreasing the period is equivalent to increasing the frequency.

The first clock divider 210 is configured to receive the time-varying signal and to decrease the frequency and/or increase the period of the time-varying signal, and to provide the resulting divider output to the multiplexer 212. For example, if the time-varying signal from the oscillator 204 has a period of x seconds, the first clock divider 210 may change the period to mx seconds, where m is greater than or equal to 1. Note that increasing the period is equivalent to decreasing the frequency.

The first multiplexer 212 is configured to receive the multiplier output and the divider output and, depending on the mode of operation of the clock circuitry 202, to provide one of the multiplier output or the divider output to the first clock output 201a.

The second clock 214 operates similarly to the first clock 206. The second clock multiplier 216 may decrease the period of the oscillating signal (though the second clock multiplier 216 does not need to decrease the period by the same amount as the first clock multiplier 208). The second clock divider 218 may increase the period of the oscillating signal (though the second clock divider 218 does not need to increase the period by the same amount as the first clock divider 210). The second multiplexer 220 receives the outputs from the second clock multiplier 216 and second clock divider 218 and provides one of the outputs to the second output 201b depending on the operating mode of the clock circuitry 202.

The clock circuitry 202 may have a plurality of operating modes, including a fast clock mode, a slow clock mode, and mixed modes. In the fast clock mode, the clock circuitry 202 may be configured to set the multiplexer 212, 220 to select and use the output of the clock multipliers 208, 216 (e.g., to provide the multiplier outputs to the clock outputs 201a, 201b). In the slow clock mode, the clock circuitry 202 may be configured to set the multiplexer 212, 220 to select and use the output of the clock dividers 210, 218 (e.g., to provide the divider outputs to the clock outputs 201a, 201b). In the mixed modes, the clock circuitry 202 may adjust each multiplexer 212, 220 individually, such that one or more multiplexers may be configured to use the multiplier output, while a different set of one or more multiplexers may be configured to use the divider output.

In some examples, the operating mode of the clock circuitry 202 may depend on what the clock-operated circuitry coupled to the clock circuitry 202 is doing at a given time. For example, when receiving and transmitting communication signals, a given sample rate may be used and/or the RF switches in the system (e.g., RF switch 100, 150, 160) may have their internal switches (e.g., series and shunt switches) operated at a certain rate, which may be related to the sample rate. When another circuit component takes an action, that component may require a different clock frequency, such as a higher clock frequency. In such a case, the clock circuitry 202 could switch from slow clock mode to fast clock mode or switch the relevant multiplexer connected to the other circuit component from using the divider output to using the multiplier output. As a result, the other circuit component may receive a higher clock frequency clock signal while executing its action. Once the action is complete and/or the other circuit component has no further actions to take, the clock circuitry 202 may return to the slow clock mode and/or switch the relevant multiplexer to use the divider output.

For example, suppose the RF channels (e.g., the transmit and/or receive paths) have a sample rate of n, where n is a number of samples per second. The clock circuitry 202 may therefore provide a clock signal with a frequency, fₙ, equal to or greater than n (e.g., 2n, 3n, 5.5n and so forth). Suppose that a clock-operated temperature sensor activates periodically to take a reading of the temperature. The temperature sensor may sample the temperature (directly or indirectly) at a sample rate of kn, where k is greater than 1. As a result, the sample rate of the temperature sensor is greater than the sample rate, n, of the transmit and receive paths. As a result, the clock circuitry 202 may therefore switch from providing a divider output to providing a multiplier output to the temperature sensor and/or transmit and/or receive paths. For example, the clock signal may now have a frequency, fₖ, equal to or greater and kn (e.g., 2kn, 3kn, 5.5kn, and so forth). Once the temperature sensor has completed its reading and returns to an idle and/or slower operating state, the clock circuitry 202 may return to providing the clock signal with the frequency fₙ. In this way, the clock circuitry 202 may shift between clock signal frequencies (e.g., of fₙ or fₖ) as required.

When operating at a slower frequency, less power is used and fewer clock signals are generated. As a result, some or all of the clock-operated circuitry may generate fewer signals. As a result, the amount of noise and/or number of spurs in the circuit may be reduced, including noise and spurs with affect amplifiers (e.g., the power amplifier 152 and/or the LNA 162), the RF switches (e.g., RF switch 100), transmit and/or receive paths, or other parts of the circuit used for processing telecommunications. Additionally, because some or all of the clock-operated circuitry may only use substantial or significant amounts of power when receiving the clock signal (e.g., when detecting a clock signal edge, or a logical high voltage), and/or because said circuitry may only perform actions responsive to receiving a clock signal, the reduced frequencies may result in the circuit and/or clock-operated circuitry consuming and/or using less power on average over time.

In some examples, the clock system 200 may reduce noise and/or spurs in a given telecommunication circuit by 3 dB, 6 dB, 10 dB, and so forth.

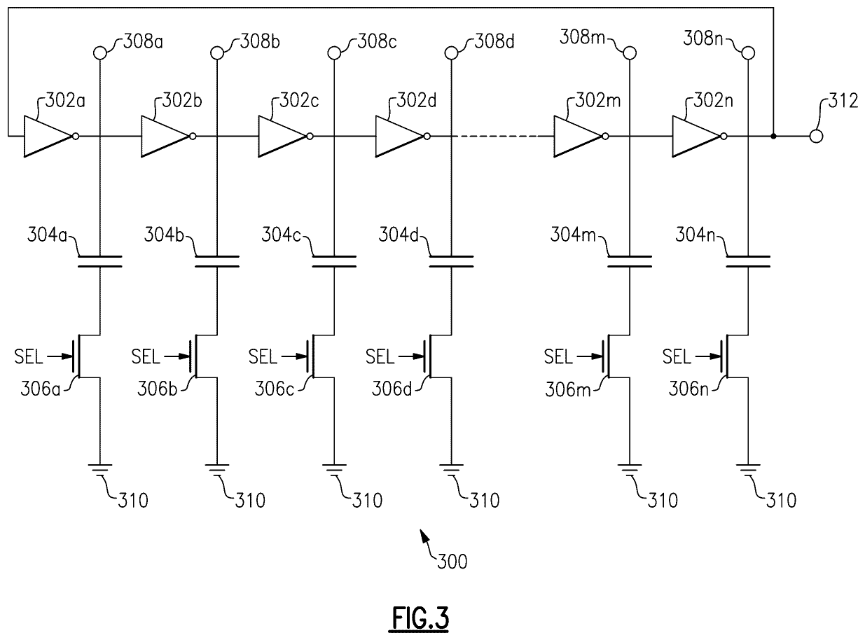

FIG. 3 illustrates a clock generator 300 according to an example. The clock generator 300 may be used to generate the slow clock signal based on the signal from the oscillator (e.g., oscillator 204 of FIG. 2) or any other source of the clock signal. The clock generator 300 includes a plurality of inverters 302a-n, a plurality of capacitors 304a-n, a plurality of switching devices 306a-n (which may be transistors, relays, or any other type of switching device), a plurality of outputs 308a-n, a reference node 310, and a clock output 312.

The clock generator 300 may be coupled together as follows. Each respective inverter 302a-n may be coupled to a respective output 308a-n, a first connection of a respective capacitor 304a-n, and an input of one other inverter 302a-n of the plurality of inverters 302a-n. Each respective capacitor 304a-n may be coupled, at a second connection of said capacitor 304a-n, to a first drain or source connection of a respective switching device 306a-n. Each respective switching device 306a-n may be coupled via a second drain or source connection to the reference node 310. The control node (e.g., gate) of each respective switching device 306a-n may be coupled to a mode selection input configured to provide a voltage to open and/or close the respective switching device 306a-n. The output of the final (e.g., the n^{th}) inverter (e.g., inverter 302n) may be further coupled to the input of first inverter (e.g., inverter 302a) and to the clock output 312.

To illustrate the coupling further, the output of the first inverter 302a may be coupled to the first output 308a, a first connection of the first capacitor 304a, and the input of the second inverter 302b. The second connection of the first capacitor 304a may be coupled to a first drain or source connection of the first switching device 306a. A second drain or source connection of the first switching device 306a may be coupled to the reference node 310, and a control node (such as a gate) of the first switching device 306a may be coupled to the mode selection input. The second inverter 302b, second capacitor 304b, second output 308b, and second switching device 306b may be coupled in like manner (with the output of the second inverter 302b coupled to the input of the third inverter 302c). This may repeat for the third, fourth, fifth, sixth, and so on inverters, capacitors, switching devices, and outputs. The final inverter 302n (the n^{th} inverter) may be similarly coupled, except that the output of the final inverter 302n is coupled to the input of the first inverter 302a and to the clock output 312.

The clock generator 300 may function as follows: when a given inverter 302a-n receives a positive input, it inverts that input to a negative input and provides the negative input to the next inverter 302a-n in the series. The next inverter 302a-n then inverts the negative input to a positive input, and provides the positive input to the next inverter 302a-n in the series. The clock signal at the clock output 312 may, therefore, oscillate between positive and negative (or logical high and low values) at a frequency related to the propagation delay of the inverters 302a-n. That is, when the first inverter 302a switches from high or low to low or high, the next inverter (e.g., the second inverter 302b) will then switch to the opposite of the output of the first inverter 302a, which will cause the third inverter 302c to switch to the same output as the first inverter 302a, and so forth through the remaining inverters of the plurality of inverters 302a-n, until the output of the last inverter 302n switches to be the same as the output of the first inverter 302a, thereby prompting the output of the first inverter 302a to flip (e.g., from low to high or high to low), and for this recursive cycle to repeat itself. Thus, the amount of time it takes the final inverter 302n to complete one cycle of low and high output may be taken as a period of the clock generator 300, and the frequency of the clock generator 300 may be determined from that in the ordinary way.

When the mode selection input provides a signal configured to turn on one or more of the switching devices 306a-n, the period of the clock generator 300 may be increased (and thus frequency of the clock generator 300 correspondingly decreased). When the switching devices 306a-n are conducting (e.g., on or closed), the output of each respective inverter 302a-n of the plurality of inverters 302a-n is AC-coupled to the reference node 310 (e.g., ground). This is because capacitors, such as the respective capacitors 304a-n of the plurality of capacitors 304a-n, act as open circuits for DC current once the capacitor is fully charged. While the respective capacitor 304a-n is charging, some or all of the output current of the respective inverter 302a-n is routed to the reference node 310 (or, alternatively, the reference node 310 pulls the voltage at the output of the respective inverters 302a-n down to the reference voltage, e.g. OV, until the respective capacitors 304a-n are charged). Once the capacitors 304a-n are charged and/or by the time the capacitors 304a-n are charged, then the voltage at the output of the respective inverters 302a-n will no longer be pulled down to the reference voltage, and so the voltage at the input of the next inverter in the series will be equal to the voltage of the output of the preceding inverter (e.g., the input voltage to the second inverter 302b will be equal to the output voltage of the first inverter 302a). When the output voltage of a given inverter 302a-n switches (e.g., high to low or low to high), the capacitors 304a-n are discharged and recharged with the opposite polarity.

The output signals of the plurality of outputs 308a-n may be provided to a clock multiplier (e.g., clock multiplier 208). The clock multiplier may use the signals from the outputs 308a-n as drive signals to generate the fast clock signal having faster speeds (e.g., generate a periodic signal having a frequency greater than the clock generator 300 and/or the oscillator 204 (or any other source of a clock signal). In some examples, the output signals of the plurality of outputs 308a-n may be the phase outputs of the generator 300.

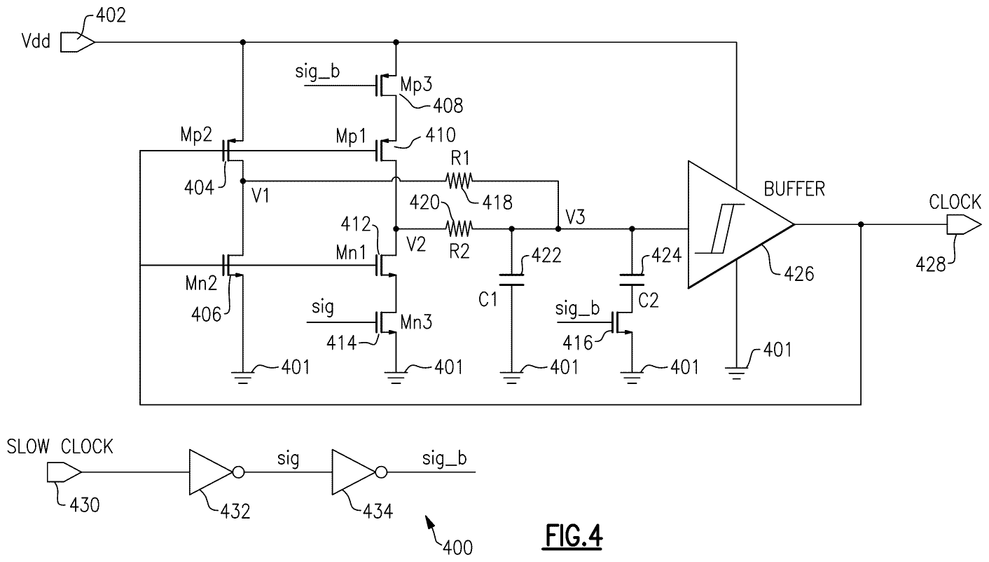

FIG. 4 illustrates a clock generator 400 according to an example. The clock generator 400 includes a high voltage rail 402 (“rail 402”), a first transistor 404, a second transistor 406, a third transistor 408, a fourth transistor 410, a fifth transistor 412, a sixth transistor 414, a seventh transistor 416, a first resistor 418, a second resistor 420, a first capacitor 422, a second capacitor 424, a buffer 426, a clock control output 428, a clock input 430, a first inverter 432, and a second inverter 434. The clock generator 400 may have a fast and slow clock mode of operation. The mode of operation of the clock generator 400 may be controlled using the clock input 430, first inverter 432, and second inverter 434.

In some examples, the first, third, and fourth transistors 404, 408, 410 may be NMOS transistors, and the second, fifth, sixth, and seventh transistors 406, 412, 414, 416 may be PMOS transistors. In other examples, the first, third and fourth transistors 404, 408, 410 may be PMOS and the second, fifth, sixth, and seventh transistors 406, 412, 414, 416 may be NMOS.

The rail 402 is coupled to a source of the first transistor 404 and third transistor 408, and to the buffer 426. A drain of the first transistor 404 is coupled to the first resistor 418 and to the drain of the second transistor 406. The source of the second transistor 406 is coupled to a reference node 401. The drain of the third transistor 408 is coupled to the source of the fourth transistor 410. The drain of the fourth transistor 410 is coupled to the drain of the fifth transistor 412 and to the second resistor 420. The source of the fifth transistor 412 is coupled to the drain of the sixth transistor 414. The source of the sixth transistor 414 is coupled to the reference node 401. The first and second resistor 418, 420 are coupled to the first capacitor 422, the second capacitor 424, and an input of the buffer 426. The first capacitor 422 is coupled to the reference node 410. The second capacitor 424 is coupled to the drain of the seventh transistor 416. The source of the seventh transistor 416 is coupled to the reference node 401. The output of the buffer 426 is coupled to the clock control output 428, and the buffer 426 is also coupled to the reference node 401. The clock control output 428 is coupled to the gates of the first, second, fourth, and fifth transistors 404, 406, 410, 412. The clock input 430 is coupled to an input of the first inverter 432. The output of the first inverter is coupled to the input of the second inverter 434 and to the gate of sixth transistor 414. The output of the second inverter 434 is coupled to the gates of the third and seventh transistors 408, 416.

When the clock input 430 is logical high, the output of the first inverter 432 is logical low and the output of the second inverter 434 is logical high. When the clock input 430 is logical low, the output of the first inverter 432 is logical high and the output of the second inverter 434 is logical low. As with the plurality of inverters 302a-n of FIG. 3, the rate at which the outputs of the inverters 432, 434 change based on changes in the inputs to the inverter 432, 434 (e.g., logical high to low or logical low to high) may depend in part on the propagation delay and/or determined by the delay provided by the first resistor 418, second resistor 420, first capacitor 422, and/or second capacitor. In some examples, the clock input 430 voltage may be equal to the clock control output 428 voltage.

When the output of the first inverter 432 is logical low, the sixth transistor 414 may be closed (e.g., on or conducting), and when the output of the first inverter 432 is logical high, the sixth transistor 414 may be open (e.g., off or non-conducting).

When the output of the second inverter 434 is logical high, the third transistor 408 is closed and the seventh transistor 416 is open, and when the output of the second inverter 434 is logical low, the third transistor 408 is open and the seventh transistor 416 is closed.

The first, second, fourth, and fifth transistors 404, 406, 410, 412 are controlled by the output of the buffer 426 (e.g., the clock control output 428). When the output of the buffer 426 is logical high, the first and fourth transistor 404, 410 are closed and the second and fifth transistor 406, 412 are open. When the output of the buffer 426 is logical low, the first and fourth transistors 404, 410 are open and the second and fifth transistors 406, 412 are closed. The buffer 426 may be an opamp/inverter buffer width and may provide, for example, unity gain for the buffer output, but an output that has a polarity opposite the input. That is, the buffer 426 may have an inverting output, such that when the input voltage is positive, the output voltage is negative, and when the input voltage is negative, the output voltage is positive.

As mentioned above, the clock input 430 and first and second inverters 432, 434 may determine the frequency of the output of the buffer 426. This operation is related to the values of the first resistor 418 and the second resistor 420, and to the paths from the input node (e.g., V3) through the first and second capacitors 422, 424 to the reference node 401. The clock generator 400 will output a slow clock signal when the seventh transistor 416 is open (e.g., off). When the seventh transistor 416 is closed (e.g., on), the clock generator 400 will output a fast clock signal having a frequency higher than that of the slow clock signal. In some examples, the closing of the seventh transistor 416 will shift the RC time constant of the clock generator 400, and in some examples the RC time constant may determine or contribute to determining the frequency of the output of the clock generator 400 (that is, the output from the buffer 426 may shift between logical high and logical low at a rate that depends on the RC time constant).

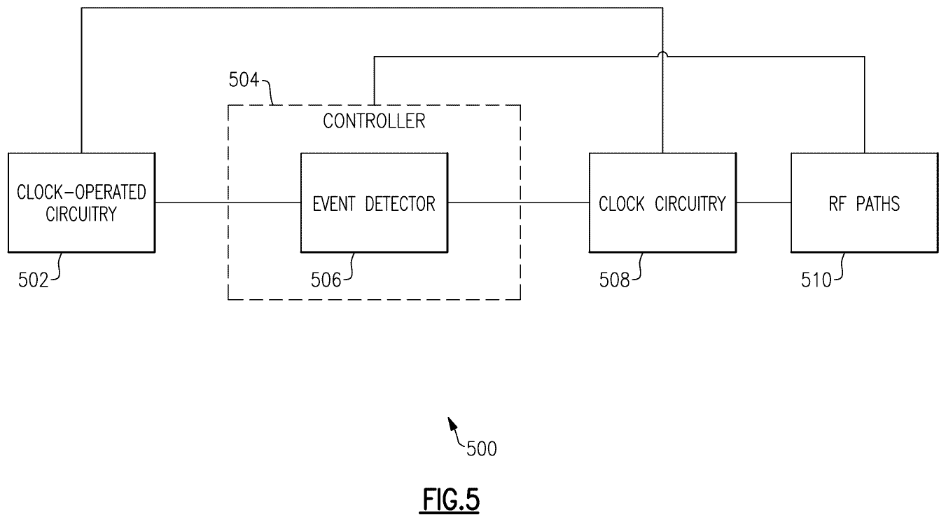

FIG. 5 illustrates a control topology 500 for a circuit having clock-operated circuitry and clock circuitry. The topology 500 includes clock-operated circuitry 502, a controller 504, an event detector 506, clock-circuitry 508, and one or more RF paths 510 (“RF paths 510”).

The clock-operated circuitry 502 is coupled to the controller 504, the event detector 506, and the clock circuitry 508. The controller 504 is coupled to the clock circuitry 508, the RF paths 510, and the clock-operated circuitry 502. The controller 504 may include the event detector 506. The event detector 506 is coupled to at least the clock-operated circuitry 502 and the clock circuitry 508. The clock circuitry 508 is coupled to the clock-operated circuitry 502, the controller 504, the event detector 506, and the RF paths 510. The RF paths 510 are coupled to the clock circuitry 508 and the controller 504.

The controller 504 may control the operation of the other elements of the topology 500. For example, the controller 504 may determine which of the transmit (TX) and receive (RX) paths are active, which signals are being transmitted, how received signals are being processed, and so forth. The controller 504 may initiate an event. For example, the controller 504 may instruct the clock-operated circuitry 502 to perform some operation. The controller 504 may also instruct the clock circuitry 508 to switch modes (e.g., to switch between slow clock and fast clock modes).

The event detector 506 may be configured to detect an action occurring that requires a change from slow clock to fast clock modes, or may be configured to detect a condition that will be followed by one or more actions requiring a change from a slow clock mode to fast clock modes. Likewise, the event detector 506 may be configured to detect when the fast clock mode is no longer required or desirable. The event detector 506 may provide an indication to the controller 504 of what has been detected. For example, the event detector 506 may provide an indication that an action has or will occur that requires a fast clock or a slow clock, and/or that the fast clock mode is no longer needed or desired.

The RF paths 510 may be configured to receive and/or transmit RF signals. The RF paths 510 may also be configured to process (e.g., filter, adjust, and so forth) RF signals).

The clock circuitry 508 may be configured to provide slow and fast clock signals. For example, the clock circuitry 508 may be implemented in some examples by using the clock circuitry 200 of FIG. 2. The clock circuitry 508 may have a plurality of modes, including fast clock modes, slow clock modes, and mixed clock modes (where some clock signals are fast and some are slow). The clock signals may be used to control and/or drive the RF paths 510 and/or clock-operated circuitry 502.

The clock-operated circuitry 502 may be circuitry configured to perform actions that include discrete segments that are triggered by a clock signal. For example, the clock-operated circuitry 502 may be a temperature sensor that takes numerous discrete samples of a voltage, current, or impedance corresponding to a temperature, where the discrete samples are taken sequentially at set intervals. Likewise, the clock-operated circuitry 502 may be calibration circuit, a charge pump, or any other circuit element of the topology 500 that uses the clock signals from the clock circuitry 508.

In some examples, the clock-operated circuitry 502 may require a fast clock signal or a clock signal that is faster than the default and/or slow clock signal provided by the clock circuitry 508. For example, if the clock-operated circuitry 502 includes a temperature sensor, the temperature sensor may need to take samples once every 1/fₖ seconds while the period of slow clock signal is 1/fₙ seconds. When the event detector 506 detects or determines that the temperature sensor is going to sense the temperature, the event detector 506 may provide a signal to the controller 504, and the controller 504 may, in turn, provide a mode selection signal to the clock circuitry 508 instructing the clock circuitry 508 to switch from slow clock mode (where the clock circuitry 508 provides a slow clock signal with a frequency of fₙ) to fast clock mode or to a mixed mode where the clock signal provided to the temperature sensor is a fast clock signal (where the fast clock signal has a frequency of fₖ). Once the temperature sensor completes its operation, the event detector 506 may detect the end of the operation and provide a signal to the controller 504. The controller 504 may then provide a mode selection signal to the clock circuitry 508 instructing the clock circuitry 508 to switch from the fast or mixed clock mode to the slow clock mode (or to another mixed clock mode where the temperature sensor is no longer provided a fast clock signal). The above example applies not just to temperature sensors, but to the clock-operated circuitry 502 and/or any components of the clock-operated circuitry 502 more generally.

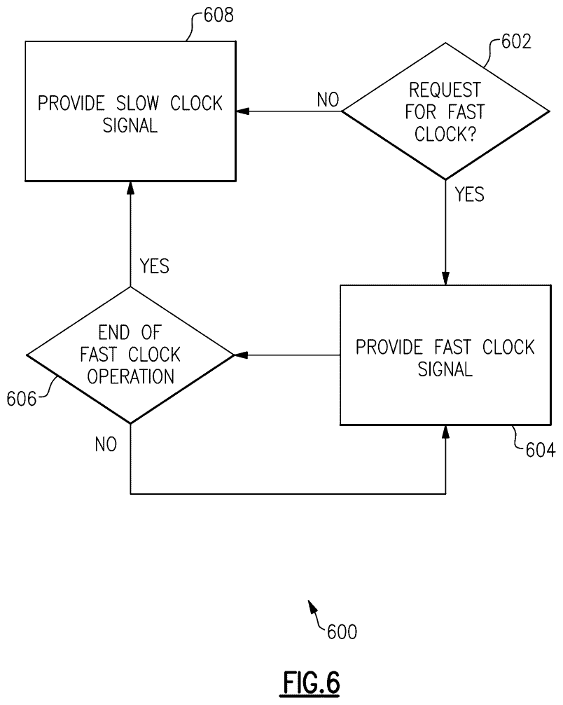

FIG. 6 illustrates a process 600 for managing a clock signal to minimize noise and/or spurs.

At act 602 the clock circuitry 508 and/or controller 504 or event detector 506 (collectively, “clock”) may receive a request for a fast clock signal or may detect a circumstance or antecedent to a state that requires or benefits from a fast clock signal. If the clock detects and/or determines that a fast clock signal will be and/or is required or beneficial (602 YES), the process 600 may proceed to act 604. If the clock does not detect and/or determine that a fast clock signal will be and/or is required or beneficial (602 NO), the process 600 may proceed to act 608.

At act 604, the clock switches from providing a slow clock signal to providing a fast clock signal. The clock may transition from one mode to another, for instance, by activating a clock multiplier circuit. The process 600 may proceed to act 606.

At act 606, the clock may determine that a fast clock signal is no longer necessary and/or beneficial, and/or detect that the operation corresponding to the fast clock signal has completed, and/or that the fast clock signal need no longer be provided. If the clock determines the fast clock signal no longer need be provided (606 YES), the process 600 may proceed to act 608. If the clock determines the fast clock signal remains required and/or beneficial, the process 600 may return to act 604.

As mentioned above, the process 600 may proceed to act 608 from act 602 or act 606. At act 608, the clock may no longer provide a fast clock signal, and may instead provide the slow clock signal (e.g., the signal provided prior to providing the fast clock signal and/or a signal that has a lower frequency than the fast clock signal).

The above is not limited to simply a fast and a slow clock signal, but a given system (e.g., topology 500 and/or the clock circuitry 508) may have multiple different fast clock signals (e.g., multiple fast clock signals each having different frequencies and/or configurable frequencies), and/or multiple different slow clock signals (e.g., multiple slow clock signals each having different frequencies and/or configurable frequencies). Some clocks and/or clock circuitry (e.g., clock circuitry 508) may provide multiple clock signals simultaneously (e.g., more than one slow and/or fast clock signal at a time).

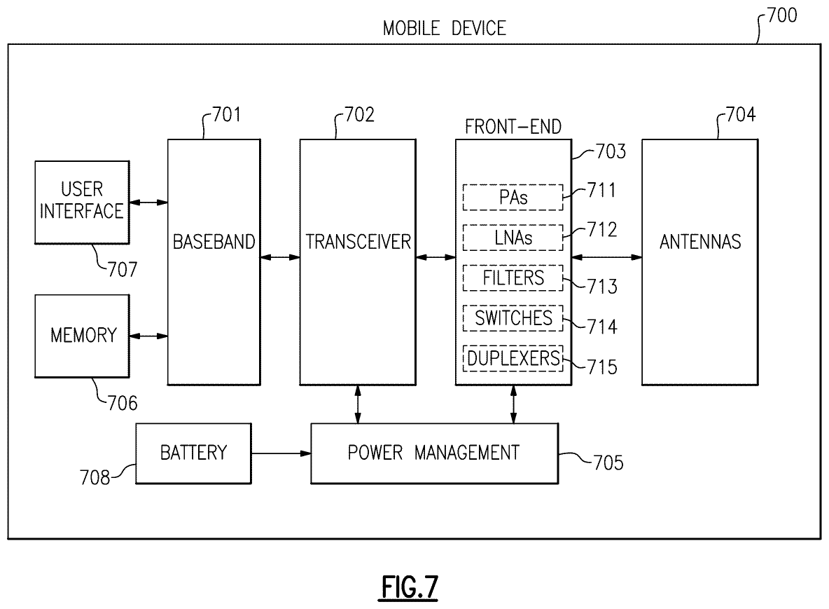

FIG. 7 is a schematic diagram of one embodiment of a mobile device 700. The mobile device 700 includes a baseband system 701, a transceiver 702, a front-end system 703, antennas 704, a power management system 705, a memory 706, a user interface 707, and a battery 708.

The mobile device 700 can be used communicate using a wide variety of communications technologies, including, but not limited to, 2G, 3G, 4G (including LTE, LTE-Advanced, and LTE-Advanced Pro), 5G NR, WLAN (for instance, Wi-Fi), WPAN (for instance, Bluetooth and ZigBee), WMAN (for instance, WiMax), and/or GPS technologies.

The transceiver 702 generates RF signals for transmission and processes incoming RF signals received from the antennas 704.

The front-end system 703 aids in conditioning signals transmitted to and/or received from the antennas 704. In the illustrated embodiment, the front-end system 703 includes power amplifiers (PAs) 711, low noise amplifiers (LNAs) 712, filters 713, switches 714, and duplexers 715. However, other implementations are possible.

For example, the front-end system 703 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 700 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band or in different bands.

The antennas 704 can include antennas used for a wide variety of types of communications. For example, the antennas 704 can include antennas for transmitting and/or receiving signals associated with a wide variety of frequencies and communications standards.

In certain implementations, the antennas 704 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 700 can operate with beamforming in certain implementations. For example, the front-end system 703 can include phase shifters having variable phase controlled by the transceiver 702. Additionally, the phase shifters are controlled to provide beam formation and directivity for transmission and/or reception of signals using the antennas 704. For example, in the context of signal transmission, the phases of the transmit signals provided to the antennas 704 are controlled such that radiated signals from the antennas 704 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 704 from a particular direction. In certain implementations, the antennas 704 include one or more arrays of antenna elements to enhance beamforming.

The baseband system 701 is coupled to the user interface 707 to facilitate processing of various user input and output (I/O), such as voice and data. The baseband system 701 provides the transceiver 702 with digital representations of transmit signals, which the transceiver 702 processes to generate RF signals for transmission. The baseband system 701 also processes digital representations of received signals provided by the transceiver 702. As shown in FIG. 7, the baseband system 701 is coupled to the memory 706 to facilitate operation of the mobile device 700.

The memory 706 can be used for a wide variety of purposes, such as storing data and/or instructions to facilitate the operation of the mobile device 700 and/or to provide storage of user information.

The power management system 705 provides a number of power management functions for the mobile device 700. In certain implementations, the power management system 705 includes a PA supply control circuit that controls the supply voltages of the power amplifiers 711. For example, the power management system 705 can be configured to change the supply voltage(s) provided to one or more of the power amplifiers 711 to improve efficiency, such as power added efficiency (PAE).

As shown in FIG. 7, the power management system 705 receives a battery voltage from the battery 708. The battery 708 can be any suitable battery for use in the mobile device 700, including, for example, a lithium-ion battery.

The front-end system 703 of FIG. 7 can be implemented in accordance with one or more features of the present disclosure. Although the mobile device 700 illustrates one example of an RF communication device that can include a RFFE system implemented in accordance with the present disclosure, the teachings herein are applicable to a wide variety of RF electronics.

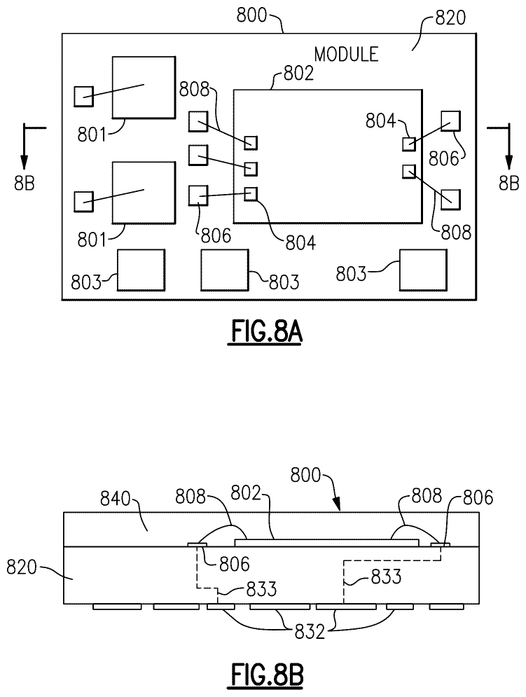

FIG. 8A is a schematic diagram of one embodiment of a packaged module 800. FIG. 8B is a schematic diagram of a cross-section of the packaged module 800 of FIG. 8A taken along the lines 8B-8B.

The RFFE systems herein can include one or more packaged modules, such as the packaged module 800. Although the packaged module 800 of FIGS. 8A-8B illustrates one example implementation of a module suitable for use in a RFFE system, the teachings herein are applicable to modules implemented in other ways.

The packaged module 800 includes radio frequency components 801, a semiconductor die 802, surface mount devices 803, wirebonds 808, a package substrate 820, and encapsulation structure 840. The package substrate 820 includes pads 806 formed from conductors disposed therein. Additionally, the semiconductor die 802 includes pins or pads 804, and the wirebonds 808 have been used to connect the pads 804 of the die 802 to the pads 806 of the package substrate 820.

As shown in FIG. 8B, the packaged module 800 is shown to include a plurality of contact pads 832 disposed on the side of the packaged module 800 opposite the side used to mount the semiconductor die 802. Configuring the packaged module 800 in this manner can aid in connecting the packaged module 800 to a circuit board, such as a phone board of a wireless device. The example contact pads 832 can be configured to provide radio frequency signals, bias signals, and/or power (for example, a power supply voltage and ground) to the semiconductor die 802. As shown in FIG. 8B, the electrical connections between the contact pads 832 and the semiconductor die 802 can be facilitated by connections 833 through the package substrate 820. The connections 833 can represent electrical paths formed through the package substrate 820, such as connections associated with vias and conductors of a multilayer laminated package substrate.

In some embodiments, the packaged module 800 can also include one or more packaging structures to, for example, provide protection and/or facilitate handling. Such a packaging structure can include overmold or encapsulation structure 840 formed over the packaging substrate 820 and the components and die(s) disposed thereon.

It will be understood that although the packaged module 800 is described in the context of electrical connections based on wirebonds, one or more features of the present disclosure can also be implemented in other packaging configurations, including, for example, flip-chip configurations.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the controller 504, may execute various operations discussed above. Using data stored in associated memory and/or storage, the controller 504 also executes one or more instructions stored on one or more non-transitory computer-readable media, which the controller 504 may include and/or be coupled to, that may result in manipulated data. In some examples, the controller 504 may include one or more processors or other types of controllers. In one example, the controller 504 is or includes at least one processor. In another example, the controller 504 performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A system for providing a clock signal to a telecommunications circuit comprising:
a clock circuit configured to provide a first clock signal having a first frequency and a second clock signal having a second frequency, the second frequency being higher than the first frequency; and
an event detector configured to
detect a plurality of events in the telecommunications circuit, the plurality of events corresponding to operations performed by components of the telecommunications circuit,
control the clock circuit to provide the second clock signal in response to detecting an event of the plurality of events for at least a duration of the event, and
control the clock circuit to provide the first clock signal and to stop providing the second clock signal after at least the duration of the event.

2. The system of claim 1 wherein the telecommunications circuit has a first operating mode and a second operating mode, and the event detector is configured to control the clock circuit to provide the first clock signal during the first operating mode and to provide the second clock signal during the second operating mode.

3. The system of claim 2 wherein the second operating mode corresponds to one or more periods of time during at least one duration of one or more events of the plurality of events.

4. The system of claim 1 wherein the plurality of events includes one or more of a switch changing state or a temperature sensor detecting a temperature.

5. The system of claim 1 wherein the system further comprises an oscillator configured to provide a periodic signal to the clock circuit.

6. The system of claim 5 wherein the system further comprises a clock generator configured to receive the periodic signal and to output one or more clock generation signals, the second clock signal being based on the one or more clock generation signals.

7. The system of claim 6 wherein the first clock signal is based on the one or more clock generation signals.

8. The system of claim 7 wherein the system further comprises a multiplexer, the multiplexer being configured to receive the first clock signal and the second clock signal and to provide one of the first clock signal and the second clock signal to the telecommunications circuit based on a control signal provided by the event detector.

9. The system of claim 8 wherein the event detector includes at least one controller configured to provide the control signal to the multiplexer based on events detected by the event detector.

10. Clock circuitry comprising:
an oscillator configured to provide a first periodic signal;
a clock multiplier coupled to the oscillator and configured to provide a second periodic signal having a frequency higher than the first periodic signal;
a clock divider coupled to the oscillator and configured to provide a third periodic signal having a frequency lower than the first periodic signal; and
a multiplexer coupled to the clock multiplier and the clock divider, the multiplexer having a multiplexer output configured to provide one of the second periodic signal or the third periodic signal to an output, the output configured to be coupled to a telecommunication circuit and configured to receive a received signal corresponding to one of the first periodic signal, second periodic signal, or third periodic signal, and configured to provide the received signal to the telecommunication circuit.

11. The clock circuitry of claim 10 wherein the clock multiplier is configured to receive the first periodic signal and to generate the second periodic signal based on the first periodic signal.

12. The clock circuitry of claim 10 wherein the clock divider is configured to receive the first periodic signal and to generate the third periodic signal based on the first periodic signal.

13. The clock circuitry of claim 12 wherein the clock multiplier is coupled to the clock divider and is configured to receive one or more periodic signals from the clock divider, the clock multiplier being further configured to generate the second periodic signal based on the one or more periodic signals.

14. The clock circuitry of claim 10 wherein the multiplexer is configured to receive the second periodic signal and the third periodic signal and to provide one of the second periodic signal or third periodic signal to the output.

15. The clock circuitry of claim 10 wherein the clock circuitry has a first mode and a second mode.

16. The clock circuitry of claim 15 wherein, in the first mode, the output receives the second periodic signal.

17. The clock circuitry of claim 16 wherein, in the second mode, the output receives the third periodic signal.

18. The clock circuitry of claim 10 further comprising an event detector, the event detector configured to detect at least one event and to provide a mode selection signal to at least the multiplexer based on the at least one event.

19. The clock circuitry of claim 18 wherein the at least one event corresponds to an operation of a circuit that requires or benefits from a fast clock signal, and wherein the event detector is configured to provide a mode selection signal to the multiplexer causing the multiplexer to provide the second periodic signal to the output.

20. The clock circuitry of claim 19 wherein the event detector is further configured to detect an end of the at least one event and, responsive to detecting the end of the at least one event, provide the mode selection signal to at least the multiplexer causing the multiplexer to provide the third periodic signal to the output.
